(19) United States
(12) Patent Application Publication
(10) Pub. No.: US 2022/0011738 A1
(43) Pub. Date: Jan. 13, 2022

(54) PROCESS MANAGEMENT DEVICE, PROCESS MANAGEMENT METHOD, AND PROCESS MANAGEMENT PROGRAM STORAGE MEDIUM

(71) Applicant: NEC Corporation, Minato-ku, Tokyo (JP)

(72) Inventor: Kenji ODA, Tokyo (JP)

(73) Assignee: NEC Corporation, Minato-ku, Tokyo (JP)

(21) Appl. No.: 17/289,563

(22) PCT Filed: Oct. 28, 2019
(86) PCT No.: PCT/JP2019/042130

§ 371 Date: Apr. 28, 2021

(30) Foreign Application Priority Data
Nov. 1, 2018 (JP) 2018-206762

(51) Int. Cl. G05B 19/406

(52) U.S. Cl. CPC G05B 19/406; G05B 2219/37533; G05B 2219/31455

(57) ABSTRACT

An abnormality in a process is grasped and a clue for determining a cause is obtained quickly. A process management device includes: a monitoring data acquisition means, a process capability index calculation means, a process capability index transition curve calculation means, a separation determination means, a change information acquisition means, and a target change information output means. The process capability index transition curve calculation means calculates a process capability index transition curve. The separation determination means calculates a separation between a process capability index and the process capability index transition curve, and determines that the separation is abnormal when the separation is equal to or more than a predetermined threshold. The change information acquisition means acquires, when the separation is abnormal, change information representing a change regarding a process in a period from a time when an abnormality is detected to a predetermined time before the time.

### TECHNICAL FIELD

The present invention relates to a process management device, a process management method, and a process management program storage medium.

### BACKGROUND ART

Statistical methods are widely used to manage a process such as a production process and an inspection process of a product. One example is process capability index. As the process capability index, there are a process capability index (Cp) that does not consider bias and a katayori process capability index (Cpk) that considers bias, and in general, Cpk that considers bias is often used. As is well known, Cpk is calculated as Cpk=(1−K)·(standard width)/(6×standard deviation), where K is bias and calculated by K=|{(upper limit standard+lower limit standard)/2)−mean value}|/{(upper limit−lower limit)/2}. The higher the value of Cp or Cpk, the higher the process capability, and the lower the value, the lower the process capability. In general, regarding Cpk, it is desirable to keep the Cpk≥1.33. It is said that improvement is required in the process if Cpk<1.00. Therefore, it is used for process management such as issuing an alarm if Cpk becomes lower than 1.33 and stopping facilities when the Cpk is below 1.00.

As described above, there is a problem that it is not possible to grasp a trend such as an improvement tendency or a deterioration tendency of Cpk only by determining whether the Cpk is below a predetermined threshold. Therefore, for example, PTL 1 discloses a technique of calculating Cpk from process data sampled at predetermined intervals and grasping the trend of Cpk. This technique divides time series data of Cpk by a predetermined number of data, sequentially transmits the data, and calculates and plots a Cpk value in each division with respect to time, thereby allowing grasping the trend of Cpk.

Further, PTL 2 discloses a method of calculating a regression equation indicating a long-term trend of Cpk from similar time-series data of Cpk and predicting a date when the Cpk drops below a threshold (lower limit).

### CITATION LIST

### Patent Literature

[PTL 1] JP 3447749 B2

[PTL 2] JP 2011-060012 A

### SUMMARY OF INVENTION

### Technical Problem

However, in the technique of PTL 1, only the trend of Cpk can be grasped, and thus when Cpk deteriorates due to a failure caused by an unexpected factor, there is a problem that clues for determining the cause cannot be obtained. In the technique of PTL 2, it is assumed that the process is always stable in order to monitor long-term changes such as life. Thus, even if a failure occurs due to an unexpected factor, only an approximate curve changes (only a warning time is advanced), and a warning cannot be given at the point when the failure occurs. Since it is result monitoring, there is a problem that no clue can be obtained for determining the cause of the failure.

### Solution to Problem

In order to solve the above problems, a process management device according to one aspect of the present invention includes: a monitoring data acquisition means, a process capability index calculation means, a process capability index transition curve calculation means, a separation determination means, a change information acquisition means, and a target change information output means. With this configuration, process monitoring data is acquired, and a process capability index is calculated for every predetermined section. Next, a regression analysis of a calculated plurality of process capability indices is performed, and an approximate curve approximating the transition of the process capability indices is calculated. Then, a predicted process capability index predicted in the future is calculated. Next, a separation between the process capability index calculated this time and the predicted process capability index is calculated, and it is determined that the separation is abnormal when the separation is equal to or more than the threshold. When it has been determined that the separation is abnormal, change information for a period from a time when an abnormality is detected to a predetermined period before the time is acquired, and is output to the outside as target change information.

### Advantageous Effects of Invention

An effect of the present invention is that it is possible to provide a process management device capable of quickly grasping an abnormality in a process and obtaining a clue for determining a cause.

### BRIEF DESCRIPTION OF DRAWINGS

FIG. 1 is a block diagram illustrating a process management device of a first example embodiment.

FIG. 2 is a block diagram illustrating a process management device of a second example embodiment.

FIG. 3 is a graph illustrating an example of data of the second example embodiment.

FIG. 4 is a flowchart illustrating operation of the second example embodiment.

### EXAMPLE EMBODIMENT

Hereinafter, example embodiments of the present invention will be described in detail with reference to the drawings. However, although the example embodiments to be described below are technically preferably limited in order to carry out the present invention, the scope of the invention is not limited to the following. Similar components in the drawings are denoted by the same reference numerals, and the description thereof may be omitted.

### First Example Embodiment

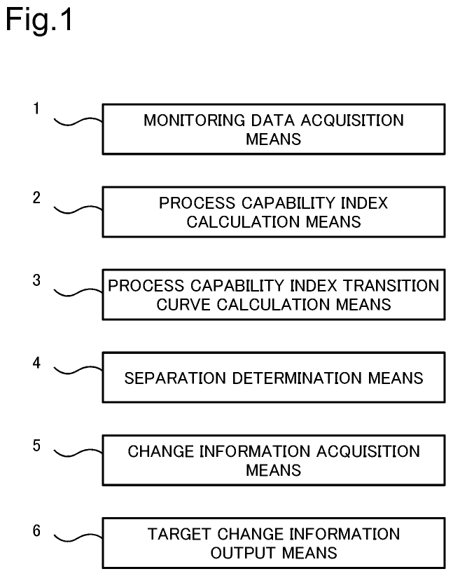

FIG. 1 is a block diagram illustrating a process management device according to the present example embodiment. A process management device has a monitoring data acquisition means 1, a process capability index calculation means 2, a process capability index transition curve calculation means 3, a separation determination means 4, a change information acquisition means 5, and a target change information output means 6.

The monitoring data acquisition means 1 acquires monitoring data for monitoring a process. Here, the monitoring data is data for monitoring a process, and specifically, for example, process data acquired in production facilities, inspection data acquired by inspection facilities, and the like.

The process capability index calculation means 2 calculates a process capability index of a process monitored with the monitoring data from a predetermined period or a predetermined number of data.

The process capability index transition curve calculation means 3 performs a regression analysis of a plurality of process capability indices calculated for each period or each counting division by the process capability index calculation means 2, and calculates an approximate curve approximating a transition of the process capability index. Then, a predicted process capability index is calculated up to the future of a predetermined period ahead.

The separation determination means 4 calculates a separation of the process capability index calculated this time from the predicted process capability index, and determines that the calculated separation is normal if the separation is less than a predetermined threshold. On the other hand, when the separation is equal to or more than the threshold, it is determined that the separation is abnormal. When it has been determined that the separation is abnormal, a message notifying that an abnormality is detected is transmitted to the change information acquisition means 5.

Upon receiving the message notifying of the abnormality, the change information acquisition means 5 acquires change information in a period from a time when the abnormality is detected to a predetermined period before the time. Here, the change information is, for example, information related to changes of Man, Machine, Material, and Method, that is, information related to what is called 4M.

The target change information output means 6 outputs the change information acquired by the change information acquisition means 5 in the period from abnormality detection to the predetermined period before as target change information to the outside.

As described above, according to the present example embodiment, it is possible to quickly detect an abnormality by detecting a change in the process capability index that is different from that in the trend until then, and to quickly acquire change information for estimating the cause of the abnormality.

### Second Example Embodiment

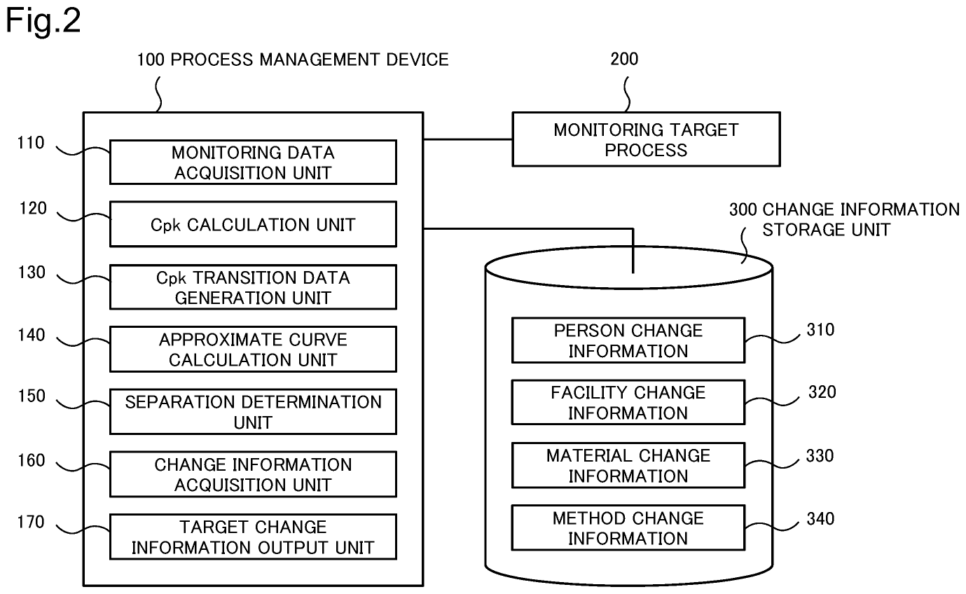

FIG. 2 is a block diagram illustrating the process management device 100 of a second example embodiment. The process management device 100 includes a monitoring data acquisition unit 110, a Cpk calculation unit 120, a Cpk transition data generation unit 130, an approximate curve calculation unit 140, a separation determination unit 150, a change information acquisition unit 160, and a target change information output unit 170. As hardware of the process management device 100, for example, a general computer including a processor and a memory can be used.

The monitoring data acquisition unit 110 acquires monitoring data from a monitoring target process 200. The monitoring data includes, for example, process data of facilities, inspection data of inspection facilities, and the like.

The Cpk calculation unit 120 calculates, from monitoring data of a predetermined period or a predetermined number of sections, the process capability index Cpk of the process in the sections.

The Cpk transition data generation unit 130 generates Cpk transition data in which Cpk of each section calculated by the Cpk calculation unit 120 is arranged in time series.

The approximate curve calculation unit 140 performs a regression analysis of Cpk transition data to calculate an approximate curve approximating the transition of Cpk. The approximate curve can be calculated by a method suitable for the monitoring target, and for example, a short regression analysis method, an exponential smoothing method, a Holt-Winters method, a recursive neural network method, or the like can be used. The calculation of approximate curve is performed from the time related to the last calculated Cpk to a predetermined period in the future. A future Cpk predicted by the calculation of approximate curve is called a predicted Cpk.

The separation determination unit 150 calculates a separation of the Cpk calculated this time from the predicted Cpk and compares the separation with a predetermined threshold. If the separation is less than the threshold, it is determined that the separation is normal. On the other hand, when the separation is equal to or more than the threshold, it is determined that the separation is abnormal, and an abnormality notification message notifying of an abnormality of Cpk is transmitted to the change information acquisition unit 160.

Upon receiving the abnormality notification message, the change information acquisition unit 160 refers to a change information storage unit 300 and acquires change information in a period from abnormality detection to a predetermined period in the past. The change information stored in the change information storage unit 300 includes, for example, person change information 310, facility change information 320, material change information 330, and method change information 340. These are information that is what is called 4M and considered important at manufacturing sites. As hardware of the change information storage unit 300, for example, a general storage device such as a hard disk or a semiconductor memory can be used.

The target change information output unit 170 outputs change information in the target period. At this time, for example, time series data of Cpk and the approximate curve may be superimposed and displayed on a display unit, and the change information may be displayed in a form linked to the display. Alternatively, the change information may be output as data to an external device or printed out.

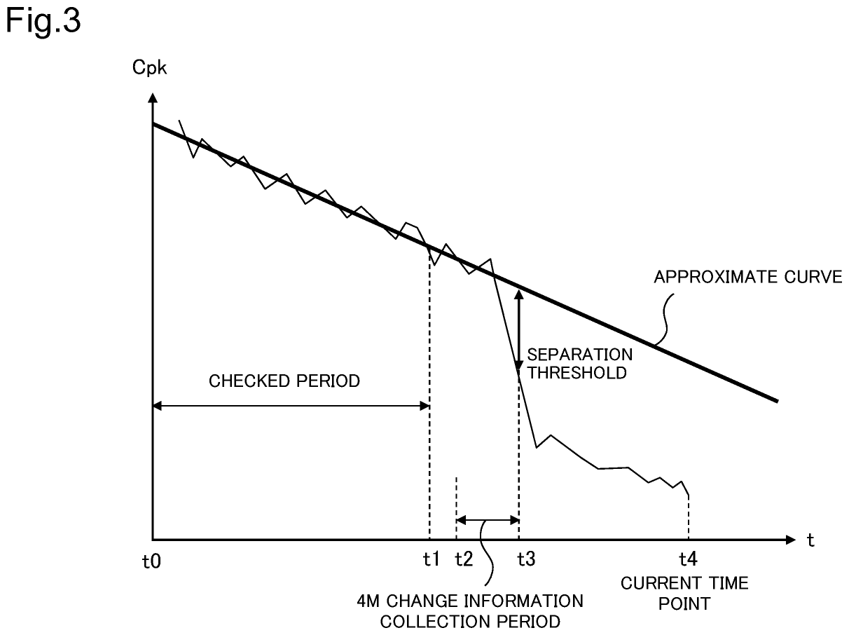

FIG. 3 is an example of a graph in which the Cpk transition data and the approximate curve are superimposed and plotted. In FIG. 3, a graph illustrated by a thin curve represents Cpk at each time. From t0 to t1 in the graph is the checked period for which Cpk is checked to be normal. After t1, there is a point at which Cpk drops sharply, and at time t3, the separation exceeds the threshold. If the separation exceeds the threshold, the separation determination unit 150 transmits the abnormality notification message to the change information acquisition unit 160, and the change information acquisition unit 160 acquires change information immediately before detecting the abnormality. In FIG. 3, the period from time t3 when the abnormality is detected to time t2 before the predetermined period is a 4M change information collection period for acquiring the change information regarding the 4M described above. Then, the target change information output unit 170 outputs the change information acquired in this period as target change information.

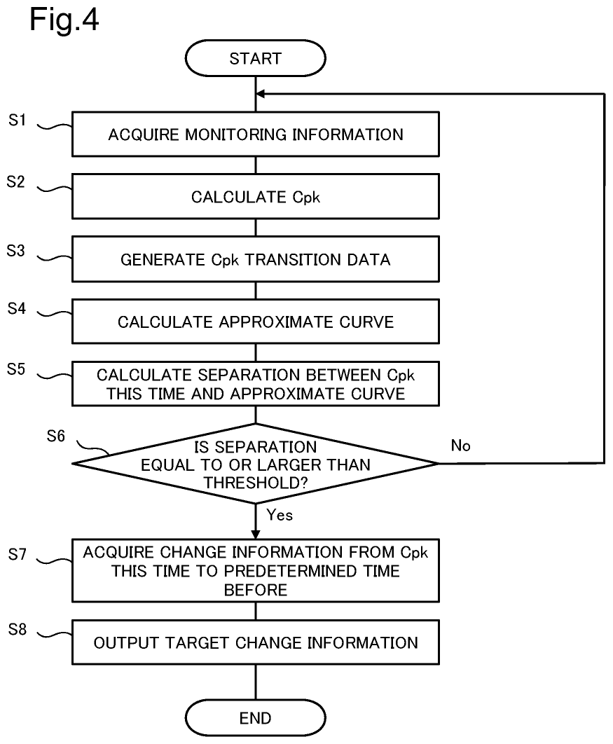

FIG. 4 is a flowchart illustrating operation of the process management device 100. The process management device 100 first acquires monitoring information (S1). Next, Cpk for every predetermined section is calculated (S2). Then, Cpk transition data is generated (S3). Next, an approximate curve is calculated by a predetermined method (S4). Next, the separation between the Cpk calculated this time and the predicted Cpk predicted from the approximate curve is calculated (S5). If the separation is less than the threshold, it is determined that the separation is normal (S6_No), and the process returns to S1. On the other hand, if the separation is equal to or more than the threshold (S6_Yes), change information for a period from the present (time of Cpk calculated this time) to a predetermined time before is acquired (S7). Next, the change information in the period is output as target change information (S8).

As described above, according to the present example embodiment, an abnormality of the monitoring process can be quickly detected, and change information having a high possibility of being related to the abnormality can be acquired by linking with the abnormality. Although the above description has been carried out by using Cpk, the above description can be similarly applied by replacing the Cpk with Cp.

A program for causing a computer to execute the processing of the first or second example embodiment described above and a recording medium storing the program are also included in the scope of the present invention. As the recording medium, for example, a magnetic disk, a magnetic tape, an optical disk, a magneto-optical disk, a semiconductor memory, or the like can be used.

The present invention has been described using the above-described example embodiments as exemplary examples. However, the present invention is not limited to the example embodiments described above. That is, the present invention can be applied in a variety of modes that can be understood by those skilled in the art within the scope of the present invention.

This application is based upon and claims the benefit of priority from Japanese patent application No. 2018-206762, filed on Nov. 1, 2018, the disclosure of which is incorporated herein in its entirety by reference.

### REFERENCE SIGNS LIST

1, 100 process management device
2 process capability index calculation means
3 process capability index transition curve calculation means
4 separation determination means
5 change information acquisition means
6 target change information output means
110 monitoring data acquisition unit
120 Cpk calculation unit
130 Cpk transition data generation unit
140 approximate curve calculation unit
150 separation determination unit
160 change information acquisition unit
170 target change information output unit
200 monitoring target process
300 change information storage unit

What is claimed is:

1. A process management device comprising:
a memory storing instructions; and
one or more processors configured to execute the instructions to:
acquire monitoring data representing a state of a process;
calculate, from monitoring data of sections divided by a predetermined period or a predetermined number, a process capability index in the sections;
perform a regression analysis of a plurality of the process capability indices calculated in the sections, and calculate a process capability index transition curve representing a transition of the process capability indices in the sections and in a future;
calculate a separation between the process capability index calculated at a present time and the process capability index transition curve, and determining that the separation is abnormal when the separation is equal to or more than a predetermined threshold;
acquire, when the separation determination means has determined that the separation is abnormal, change information representing a change regarding the process in a period from a time when an abnormality is detected to a predetermined time before the time; and
output as target information the change information that is acquired.

2. The process management device according to claim 1, wherein the process is a production process, and the monitoring data is data regarding production facilities related to the production process.

3. The process management device according to claim 1, wherein the process is an inspection process, and the monitoring data is data regarding inspection facilities related to the inspection process.

4. The process management device according to claim 1, wherein the change information includes at least one of person change information regarding a person, facility change information regarding facilities, material change information regarding a material, and method change information regarding a method.

5. The process management device according to claim 1, wherein the process capability index is a process capability index (Cpk) in consideration of bias.

6. A process management method comprising:
acquiring monitoring data representing a state of a process;
calculating, from monitoring data of sections divided by a predetermined period or a predetermined number, a process capability index in the sections;
performing a regression analysis of a plurality of the process capability indices calculated in the sections, and calculating a process capability index transition curve representing a transition of the process capability indices in the sections and in a future;
calculating a separation between the process capability index calculated at a present time and the process capability index transition curve;
determining that the separation is abnormal when the separation is equal to or more than a predetermined threshold;
acquiring, when it has been determined that the separation is abnormal, change information representing a change regarding the process in a period from a time when an abnormality is detected to a predetermined time before the time; and
outputting as target information the change information that is acquired.

7. The process management method according to claim 6, wherein the change information includes at least one of person change information regarding a person, facility change information regarding facilities, material change information regarding a material, and method change information regarding a method.

8. The process management method according to claim 6, wherein the process capability index is a process capability index (Cpk) in consideration of bias.

9. A non-transitory computer-readable process management program storage medium storing a process management program for causing a computer to execute processing comprising:
a step of acquiring monitoring data representing a state of a process;
a step of calculating, from monitoring data of sections divided by a predetermined period or a predetermined number, a process capability index in the sections;
a step of performing a regression analysis of a plurality of the process capability indices calculated in the sections, and calculating a process capability index transition curve representing a transition of the process capability indices in the sections and in a future;
a step of calculating a separation between the process capability index calculated at a present time and the process capability index transition curve;
a step of determining that the separation is abnormal when the separation is equal to or more than a predetermined threshold;
a step of acquiring, when it has been determined that the separation is abnormal, change information representing a change regarding the process in a period from a time when an abnormality is detected to a predetermined time before the time; and
a step of outputting as target information the change information that is acquired.

10. The non-transitory process management program storage medium according to claim 9, wherein the change information includes at least one of person change information regarding a person, facility change information regarding facilities, material change information regarding a material, and method change information regarding a method.
